(19) United States
(12) Patent Application Publication
(10) Pub. No.: US 2021/0354284 A1
(43) Pub. Date: Nov. 18, 2021

(54) CENTER LINE PLANNING DEVICE

(71) Applicant: ACCU JIANGSU CO. , LTD, Suzhou, Jiangsu (CN)

(72) Inventor: DanLei You, Jiangsu (CN)

(21) Appl. No.: 17/044,309

(22) PCT Filed: Aug. 30, 2019
(86) PCT No.: PCT/CN2019/103475

§ 371 Date: Jun. 23, 2021

(30) Foreign Application Priority Data
Dec. 26, 2018 (CN) 201811597725.8

(51) Int. Cl. B25H 7/04; B25H 7/00

(52) U.S. Cl. CPC B25H 7/04; B25H 7/005

(57) ABSTRACT

The present invention discloses a center line planning device, comprising a fixed support, a movable support, said movable support connected to said fixed support in a movable form, the head end of the first connecting rod hinged on the fixed support, the head end of the second connecting rod hinged on the movable support, the tail end of the first connecting rod and the tail end of the second connecting rod hinged together, the length of the first connecting rod equal to the length of the second connecting rod; the hinge position between the tail end of the first connecting rod and the tail end of the second connecting rod provided with a marking tool. The present invention utilizes the principle of coincident median and altitude in an isosceles triangle to design said center line planning device that facilitates workers to identify and confirm the center lines of axial parts, such as square tubes and round tubes, so as to pave the way for further processing of the raw materials.

### BACKGROUND OF INVENTION

### 1. Field of the Invention

The present invention relates generally to the field of production technique, and more particularly to an auxiliary device for processing raw materials.

### 2. Description of Related Art

To process raw materials into various shapes, it is necessary to identify the center line of the raw material. For example, to produce an open slot or a hole on a round tube or a square tube, the center line of the round tube or square tube must be firstly identified in order for the center of the open slot or hole to be produced fall on the center line.

### SUMMARY OF THE INVENTION

The technical problem to be solved by the present invention: easily identifying the center line of the raw material.

In order to solve the above technical problem, the present invention provides the following technical solution: a center line planning device, comprising a fixed support and a movable support, said movable support connected to said fixed support in a movable form, the head end of the first connecting rod hinged on the fixed support, the head end of the second connecting rod hinged on the movable support, the tail end of the first connecting rod hinged on the tail end of the second connecting rod, the length of the first connecting rod equal to the length of the second connecting rod; the hinge point between the head end of the first connecting rod and the fixed support being the first hinge point, the hinge point between the head end of the second connecting rod and the movable support being the second hinge point; the movable support and the fixed support clamping on the two sides of the raw material, the midpoint of the connecting line connecting said first hinge point and said second hinge point falling on the center line of the raw material; the hinge position between the tail end of the first connecting rod and the tail end of the second connecting rod provided with a marking tool.

The movable support can move in relation to the fixed support, toward or away from the fixed support, so as to suit different outer diameters of the raw material.

As the lengths of the first connecting rod and the second connecting rod length are equal, and, when the movable support and the fixed support clamp the two sides of the raw material, the midpoint of the connecting line connecting said first hinge point and said second hinge point falls on the center line of the raw material, i.e., the midpoint of the connecting line between the head end of the first connecting rod and the head end of the second connecting rod falls on the center line of the raw material, the first connecting rod, the second connecting rod, and the connecting line between the head end of the first connecting rod and the head end of the second connecting rod form an isosceles triangle, the altitude and median of the isosceles triangle coincide, no matter how the distance between the head end of the first connecting rod and the head end of the second connecting rod changes, i.e., no matter how the outer diameter of the raw material changes, the hinge point between the tail end of the first connecting rod and the tail end of the second connecting rod will always fall on the center line of the raw material. Thus, the marking tool is always on the center line of the raw material. By dragging the center line planning device disclosed in the present invention along the length of the raw material, said marking tool can mark the center line of the raw material on the outer wall of the raw material.

The present invention utilizes the principle of coincident median and altitude in an isosceles triangle to design said center line planning device that facilitates workers to identify and confirm the center lines of axial parts like square tubes, round tubes etc, so as to pave the way for further processing of the raw materials.

### BRIEF DESCRIPTION OF THE DRAWINGS

Further descriptions of the invention are provided below with reference to the accompanying drawings:

FIG. 1 is a combined perspective view of the center line planning device and the raw material;

FIG. 2 is a schematic view of the marking sleeve in FIG. 1.

### DETAILED DESCRIPTION OF THE INVENTION

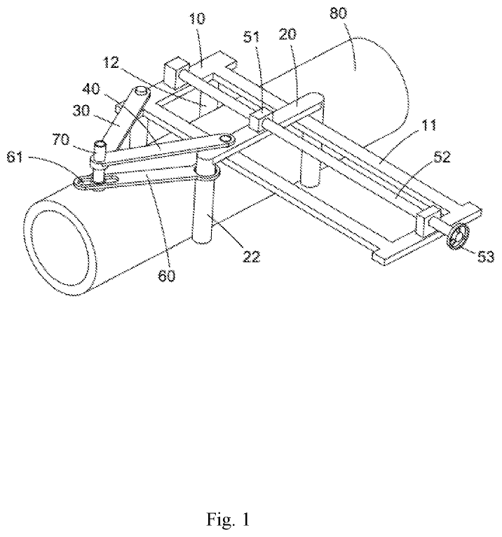

FIG. 1 discloses a center line planning device, comprising a fixed support 10, a movable support 20, a first connecting rod 30, a second connecting rod 40, a third connecting rod 60, and marking tool.

The movable support 20 is connected to said fixed support 10 through a screw rod mechanism. The fixed support is provided with a sliding rail 11, and the movable support is installed on said sliding rail. The screw nut 51 of the screw rod mechanism is installed on the movable support, the head end of the screw rod 52 of the screw rod mechanism is pivoted on the fixed support, and the tail end of the screw rod mechanism is provided with a turn handle 53. By turning said turn handle, the screw rod will drive the movable support through said screw nut to move along the sliding rail of the fixed support, and the movable support will move toward or away from the fixed support, so as to suit different outer diameters of the raw material.

The fixed support 10 is provided with a pair of first rollers 12, the movable support 20 is provided with a pair of second rollers 22, and the plane formed by the center lines around which the pair of first rollers rotate is parallel to the plane formed by the center lines around which the pair of second rollers rotate. In this way, when the fixed support and the movable support clamps the two sides of the raw material tightly in opposite directions, the pair of first rollers on the left side of the raw material can simultaneously push the left side of the raw material, the pair of second rollers on the right side of the raw material will simultaneously push the right side of the raw material, making sure that the center line planning device stably clamps the raw material.

The head end of the first connecting rod 30 is hinged on the fixed support, the head end of the second connecting rod 40 is hinged on the movable support, the tail end of the first connecting rod and the tail end of the second connecting rod are hinged together, and the length of the first connecting rod is equal to the length of the second connecting rod.

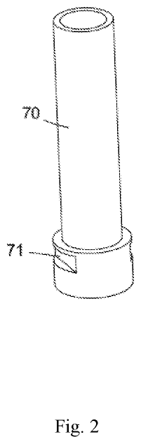

Referring to FIG. 2, said marking tool comprises a marking sleeve 70 and a marker, said marker is inserted into said marking sleeve, the tail end of the first connecting rod 30 is provided with a first hinge hole, the tail end of the second connecting rod 40 is provided with a second hinge hole, the upper half portion of the marking sleeve is inserted into the first hinge hole and the second hinge hole, so that the tail end of the first connecting rod and the tail end of the second connecting rod are hinged together. The marking sleeve can move along the direction of the axis of the first hinge hole and the second hinge hole, and the marking sleeve can rotate inside the first hinge hole and the second hinge hole.

Among the pair of first rollers 12, the first roller adjacent to the tail end of the first connecting rod 30 is provided with external screw threads, alternatively, among the pair of second rollers 22, the second roller adjacent to the tail end of the second connecting rod 40 is provided with external screw threads, the head end of the third connecting rod 60 is screwed on the first roller or the second roller that is provided with external screw threads. The tail end of the third connecting rod 60 is provided with an open slot 61, the lower half portion of the marking sleeve 70 is provided with a sliding chute 71, the lower half portion of the marking sleeve is fitted on said open slot, and the side wall of the open slot is fitted on said sliding chute, so that the side wall of the open slot can slide along the sliding chute.

In actual operation, the distance between the fixed support 10 and the movable support 20 is adjusted by turning the turn handle 53 to fit the outer diameter of the raw material, so that the pair of first rollers 12 and the pair of second rollers 22 will push against the left and right sides of the raw material. Meanwhile, manually control the height of the center line planning device so that the bottom end of the marker contacts the raw material. Specifically, it is assumed that the hinge point between the head end of the first connecting rod and the fixed support is the first hinge point, the hinge point between the head end of the second connecting rod and the movable support is the second hinge point, and the midpoint of the connecting line connecting said first hinge point and said second hinge point falls on the center line of the raw material.

Then, said center line planning device is moved manually along the length of the raw material, so that the marker can mark the center line of the raw material on the outer wall of the raw material.

During the marking process, the bottom end of the marker will be gradually shortened due to the wearing. To solve this problem, in the present invention, said third connecting rod 60 will gradually descend under the drive by the external screw threads on the first roller or the second roller and the marking sleeve 70 will gradually descend under the guidance of the first hinge hole and the second hinge hole, the third connecting rod will pull the marking sleeve 70 gradually downward along the first hinge hole and the second hinge hole, and the marking sleeve 70 will brings the marker inside it to go downward, making sure the bottom end of the marker contacts the outer wall of the raw material, and the center line of the raw material can be smoothly marked out.

1. A center line planning device, comprising a fixed support (10) and a movable support (20), said movable support connected to said fixed support in a movable form, having the following characteristics: the head end of the first connecting rod (30) is hinged on the fixed support, the head end of the second connecting rod (40) is hinged on the movable support, the tail end of the first connecting rod and the tail end of the second connecting rod are hinged together, the length of the first connecting rod is equal to the length of the second connecting rod;
the hinge point between the head end of the first connecting rod and the fixed support is the first hinge point, the hinge point between the head end of the second connecting rod and the movable support is the second hinge point;
the movable support and the fixed support clamp the two sides of the raw material, and the midpoint of the connecting line connecting said first hinge point and said second hinge point falls on the center line of the raw material;
the hinge position between the tail end of the first connecting rod and the tail end of the second connecting rod is provided with a marking tool.

2. The center line planning device defined in claim 1, characterized in that: the movable support (20) is connected to said fixed support (10) through a screw rod mechanism;
the fixed support is provided with a sliding rail (11), the movable support is fitted on said sliding rail; the screw nut (51) of the screw rod mechanism is installed on the movable support, the head end of the screw rod (52) of the screw rod mechanism is pivoted on the fixed support, and the tail end of the screw rod mechanism is provided with a turn handle (53).

3. The center line planning device defined in claim 1, characterized in that: the fixed support (10) is provided with a pair of first rollers (12), the movable support (20) is provided with a pair of second rollers (22), the plane formed by the center lines around which the pair of first rollers rotates is parallel to the plane formed by the center lines around which the pair of second rollers rotates.

4. The center line planning device defined in claim 3, characterized in that:
among the pair of first rollers (12), the first roller adjacent to the tail end of the first connecting rod (30) is provided with external screw threads, alternatively, among the pair of second rollers (22), the second roller adjacent to the tail end of the second connecting rod (40) is provided with external screw threads, and the head end of the third connecting rod (60) is screwed on the first roller or the second roller that is provided with external screw threads;
said marking tool comprises a marking sleeve (70) and a marker, said marker is inserted inside the marking sleeve, the tail end of the first connecting rod (30) is provided with a first hinge hole, the tail end of the second connecting rod (40) is provided with a second hinge hole, the upper half portion of the marking sleeve is inserted into the first hinge hole and the second hinge hole, the marking sleeve can move along the axial direction of the first hinge hole and the second hinge hole, and the marking sleeve can rotate inside the first hinge hole and the second hinge hole; the tail end of the third connecting rod is connected to the marking sleeve in a movable form.

5. The center line planning device defined in claim 4, characterized in that: the tail end of the third connecting rod (60) is provided with an open slot (61), the lower half portion of the marking sleeve (70) is provided with a sliding chute (71), the lower half portion of the marking sleeve is fitted on said open slot, the side wall of the open slot is fitted on said sliding chute, and the side wall of the open slot can slide along the sliding chute.
